(19) United States
(12) Patent Application Publication
(10) Pub. No.: US 2025/0257652 A1
(43) Pub. Date: Aug. 14, 2025

(54) A LINEAR CUT GENERATION METHOD FOR SENSOR INVERSION CONSTRAINT IMPOSITION

(71) Applicant: SCHLUMBERGER TECHNOLOGY CORPORATION, Sugar Land, TX (US)

(72) Inventors: Kashif RASHID, Cambridge, MA (US); Lukasz ZIELINSKI, Cambridge, MA (US); Andrew J. SPECK, Cambridge, MA (US); Junyi YUAN, Cambridge, MA (US)

(21) Appl. No.: 19/100,481

(22) PCT Filed: Aug. 3, 2023
(86) PCT No.: PCT/US2023/029361

§ 371 Date: Jan. 31, 2025

Related U.S. Application Data
(60) Provisional application No. 63/370,285, filed on Aug. 3, 2022.

(51) Int. Cl. E21B 47/117

(52) U.S. Cl. CPC E21B 47/117

(57) ABSTRACT

Embodiments presented provide for a method of analysis for methane leaks. The method of analysis includes performing a record generation event, performing a quality assessment of the record generation event, performing a linear cut generation procedure to create a linear cut generation data set, and performing a source term inversion using the linear cut generation data set.

### CROSS-REFERENCE TO RELATED APPLICATIONS

The present patent application is an International Application that claims priority to U.S. Provisional Patent Application No. 63/370,285 that was filed on Aug. 3, 2022, which is herein incorporated by reference in its entirety.

### FIELD OF THE DISCLOSURE

Aspects of the disclosure relate to identification of source contaminants in a field. More specifically, aspects of the disclosure relate to providing a linear cut evaluation method to help identify and quantify methane leakage into an environment.

### BACKGROUND

Quantification of environmental contaminants in the environment is becoming more important as companies and nations seek to cut air pollution. Historically, methane leaks were allowed in oil field service operations as remediation of these leaks could be economically costly.

With the advent on attempts to curb greenhouse gas emissions, methane has come under increasingly stringent review. Current methods for identification of methane leaks are based upon conventional fluid dynamics equations. Unfortunately, placements of sensors, variability of environmental conditions and other constraints hinder the overall ability of operators to identify and quantify methane leaks in the field to levels currently desired.

There is a need to provide an apparatus and methods that are easier to operate than conventional apparatus and methods for quantification and characterization of methane leaks in the environment.

There is a still further need to reduce economic costs associated with operations and apparatus for quantification of methane leads pertaining to conventional tools and methods.

### SUMMARY

So that the manner in which the above recited features of the present disclosure can be understood in detail, a more particular description of the disclosure, briefly summarized below, may be had by reference to embodiments, some of which are illustrated in the drawings. It is to be noted that the drawings illustrate only typical embodiments of this disclosure and are therefore not to be considered limiting of its scope, for the disclosure may admit to other equally effective embodiments without specific recitation. Accordingly, the following summary provides just a few aspects of the description and should not be used to limit the described embodiments to a single concept.

In one example embodiment, a method for evaluating the presence of a methane leak is disclosed. The method may comprise performing a record generation event and performing a quality assessment of the record generation event. The method may also comprise performing a linear cut generation of the record generation event after the quality assessment to create a linear cut generation data set. The method may further comprise performing a source term inversion subject to the linear cut generation data set.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the drawings. It is to be noted, however, that the appended drawings illustrate only typical embodiments of this disclosure and are therefore not be considered limiting of its scope, for the disclosure may admit to other equally effective embodiments.

FIG. 1 is a depiction of a mathematical model for an inversion procedure for data, in one example embodiment of the disclosure.

FIG. 2 is a high-level cone generation schema in one example embodiment of the disclosure.

FIG. 3A is a cone generation and data processing sensor step in one example embodiment of the disclosure.

FIG. 3B is a wedge generation processing step in one example embodiment of the disclosure.

FIG. 3C is a cone identification processing method in one example embodiment of the disclosure.

FIG. 3D is a graph of cone generation and acceptance criteria in one example embodiment of the disclosure.

FIG. 4A is a cone generation plot for a sensor 3 in one example embodiment of the disclosure.

FIG. 4B is a cone generation plot for a sensor 14 in one example embodiment of the disclosure.

FIG. 4C is a cone generation plot for a sensor 22 in one example embodiment of the disclosure.

FIG. 4D is a cone generation plot for a sensor 23 in one example embodiment of the disclosure.

FIG. 4E is a cone generation plot for a sensor 24 in one example embodiment of the disclosure.

FIG. 4F is a cone generation plot for a sensor 25 in one example embodiment of the disclosure.

FIG. 5A is a constrained plot plan in x and y coordinates of linear cuts and sub bounds for case 26 in one example embodiment of the disclosure.

FIG. 5B is a constrained objective evaluation at a known source (left) and at a solution (right) in one example embodiment of the disclosure.

FIG. 6A is a bound constrained plot plan in the x and y axis for case 26.

FIG. 6B is a constrained objective evaluation for case 26 at a known source (left) and at a solution (right) in one example embodiment of the disclosure.

FIG. 7A is a graph of multiple cones with linear cuts, mid angle cuts and sub-bounds.

FIG. 7B is a graph of a single cone with linear cuts, mid angle cuts and sub-bounds.

FIG. 8A is a graph of two cones permitting dis-ambiguation of two potential sources.

FIG. 8B is a graph of one large cone which prevents dis-amfiguation of two potential sources.

To facilitate understanding, identical reference numerals have been used, where possible, to designate identical elements that are common to the figures (“FIGS”). It is contemplated that elements disclosed in one embodiment may be beneficially utilized on other embodiments without specific recitation.

### DETAILED DESCRIPTION

In the following, reference is made to embodiments of the disclosure. It should be understood, however, that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the claims except where explicitly recited in a claim. Likewise, reference to “the disclosure” shall not be construed as a generalization of inventive subject matter disclosed herein and should not be considered to be an element or limitation of the claims except where explicitly recited in a claim.

Although the terms first, second, third, etc., may be used herein to describe various elements, components, regions, layers and/or sections, these elements, components, regions, layers and/or sections should not be limited by these terms. These terms may be only used to distinguish one element, components, region, layer or section from another region, layer or section. Terms such as “first”, “second” and other numerical terms, when used herein, do not imply a sequence or order unless clearly indicated by the context. Thus, a first element, component, region, layer or section discussed herein could be termed a second element, component, region, layer or section without departing from the teachings of the example embodiments.

When an element or layer is referred to as being “on,” “engaged to,” “connected to,” or “coupled to” another element or layer, it may be directly on, engaged, connected, coupled to the other element or layer, or interleaving elements or layers may be present. In contrast, when an element is referred to as being “directly on,” “directly engaged to,” “directly connected to,” or “directly coupled to” another element or layer, there may be no interleaving elements or layers present. Other words used to describe the relationship between elements should be interpreted in a like fashion. As used herein, the term “and/or” includes any and all combinations of one or more of the associated listed terms.

Some embodiments will now be described with reference to the figures. Like elements in the various figures will be referenced with like numbers for consistency. In the following description, numerous details are set forth to provide an understanding of various embodiments and/or features. It will be understood, however, by those skilled in the art, that some embodiments may be practiced without many of these details, and that numerous variations or modifications from the described embodiments are possible. As used herein, the terms “above” and “below”, “up” and “down”, “upper” and “lower”, “upwardly” and “downwardly”, and other like terms indicating relative positions above or below a given point are used in this description to more clearly describe certain embodiments.

Aspects of the disclosure provide a procedure to identify a set of linear cuts that may be included in the methane sensor-inversion problem to improve the efficiency of the search. In particular, two linear cuts may be generated for each fixed sensor given the available wind and concentration measurement readings taken. The extraction of valid linear cuts for a given sensor identifies a cone indicative of the anticipated leak source direction. Thus, a collection of linear cuts may serve to identify a feasible sub-space in which the leak source may reside. Mathematically, this yields a set of linear constraints that are subsequently included in the inversion step. Embodiments provided herein describes the linear cut procedure and its use in the sensor-inversion procedure.

The sensor inversion procedure is based on the following steps for a given collection of data from a given time (T=0) that is repeated periodically, perhaps, every hour:
1—Record Generation
2—Record Quality Assessment
3—Linear Cut Generation
4—Source Term Inversion
Wait for given period and then repeat.

The key assumptions are that a number of fixed methane sensors are deployed on a given site with known boundary conditions and possibly, other information pertinent to the facility layout, including the location of equipment prone to leak.

An anemometer is used to record the incumbent wind conditions (e.g., the wind speed and direction). The weather conditions (e.g., the solar intensity and cloud cover) are also recorded as these are required for the wind stability class estimation.

A simple Gaussian plume model is employed as the forward predictive model. A leak will result in a significant concentration reading at one or more sensors. The inversion process concerns identification of the source location and rate.

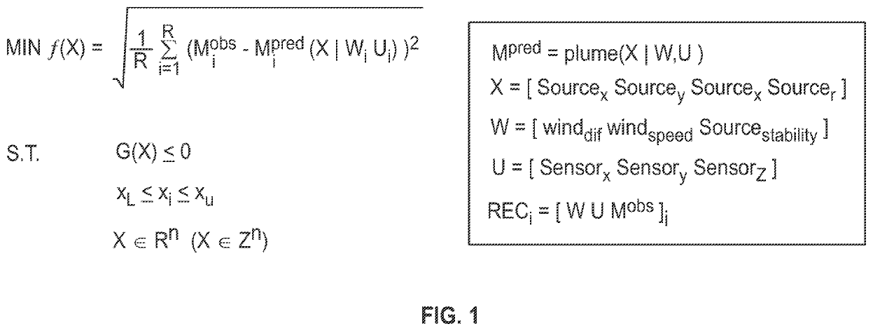

Details of the record generation and inversion procedure are known in the industry. A root mean square error (RMSE) measure is used when all records are employed with equal weighting, but a weighted mean square error measure (WMSE) is used if the records are assigned weights based on a quality measure in Step 2. Generally, the procedure is robust to mitigate against undesirable and unattainable records. The mathematical model is shown in FIG. 1. Aspects of the disclosure outline a method and procedure of step 3 (and its impact on step 4).

### FIG. 1—Inversion Problem Definition

Referring to FIG. 1, the error measure concerns minimization of the sum of residuals for each record in the collection, of size R. X defines the set of control variables (the source location and rate), while W is the wind condition and U is the sensor information associated with each record, with noted observation M^{obs}. The variables are specified within given bounds, and may be continuous or discrete depending on need. G(X) defines the set of constraints if valid linear cuts are generated and employed as part of the inversion procedure.

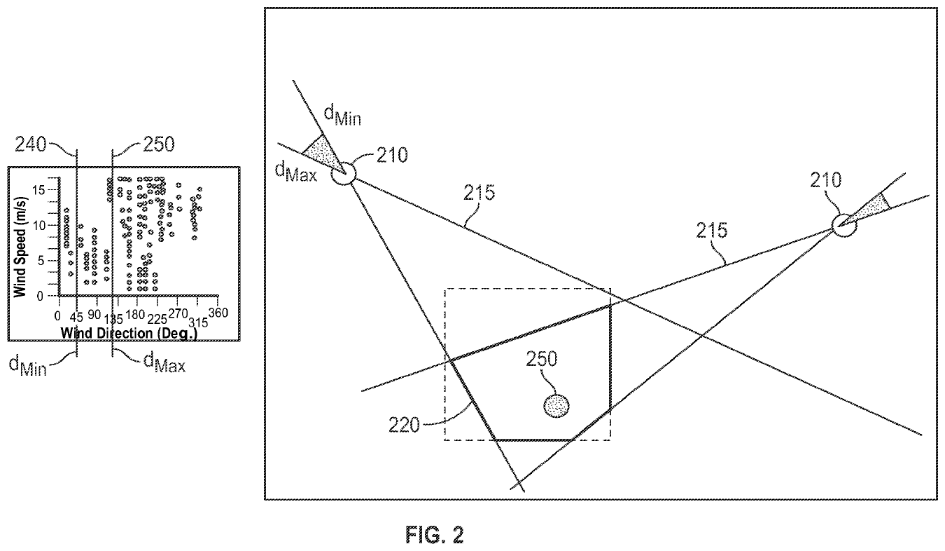

The high-level cone generation schema is shown in FIG. 2. The inset plot (top left) displays the wind-sensor data for a given sensor 210 (shown in the main plan view). The inset plot shows active readings (readings between dₘᵢₙ reference line 240 and dₘₐₓ reference line 250) where concentration level is significant and inactive readings (readings outside of dₘᵢₙ reference line 240 and dₘₐₓ reference line 250) where concentration level is below the detection threshold of the sensor employed. The minimum and maximum angles of receptivity are identified and marked by angles dₘᵢₙ and dₘₐₓ, respectively. These markers are used to set the vertical angle at the sensor giving rise to a cone (see 215 on the main plot). Multiple cones from multiple sensors can identify a feasible sub-space (see 220 on the main plot) in which the source 250 may reside. This feasible sub-space 220 is stipulated by the constraint set G(X). The reduced search bounds encasing the convex hull are also returned (not shown in FIG. 2).

### FIG. 2—Linear Cut Generation Schema

Referring to FIG. 2, the inset plot shows wind-sensor data for a sensor 210 (shown top left in the main plot). The data is plotted with active readings (readings between dₘᵢₙ reference line 240 and dₘₐₓ reference line 250) where a concentration level is significant, and the inactive readings (readings outside of dₘᵢₙ reference line 240 and dₘₐₓ reference line 250). The minimum and maximum angles of receptivity at the sensor are marked by dₘᵢₙ and dₘₐₓ, respectively. These angles are used to mark the vertical angle at the sensor giving a cone. Multiple cones can identify a feasible sub-space (see 220 on the main plot) in which a source 250 may reside.

### Single Cone Evalution

For further processing, a cone generation method is presented herein. The method entails tuning of a set of parameters that determine the minimum permissible size of the cone, the separation angle between multiple possible cones, and tests to isolate the dominant cone based on sample density and concentration, among others. Note that the wind-sensor data is first filtered based on concentration (above minimum detection threshold) and the wind speed (either too low or too high) and is sorted in ascending order of wind direction. This ensures that only suitable samples are retained for cone extraction.

The cone generation parameters are tunable, but robust default settings have been established based on performance over a set of field tests.

The following settings are established and recommended for use: Such values may be altered and should not be considered limiting:
Cone cut active level (15 ppm=3*detection threshold).
Minimum cone width (45 deg)
Minimum cone separation angle (25 deg)
Maximum cone width (180 deg) to prevent reflex angles
Minimum number of active samples (n_{act}^{min}=10).
Minimum active sample cone density (n_{act}/n=0.19), where n is the number of samples.
Minimum average active cone concentration (20 ppm).

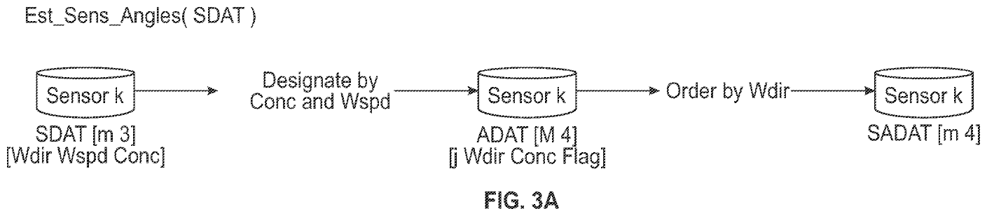

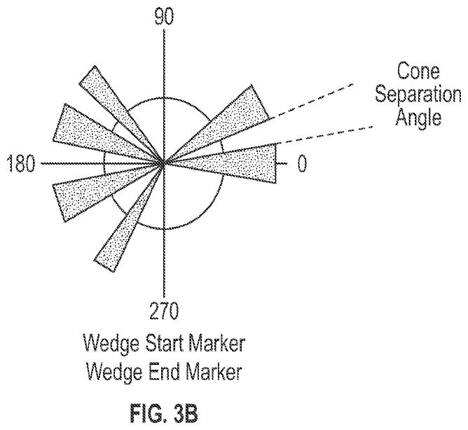

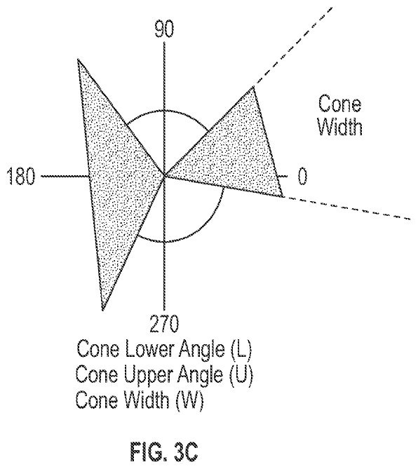

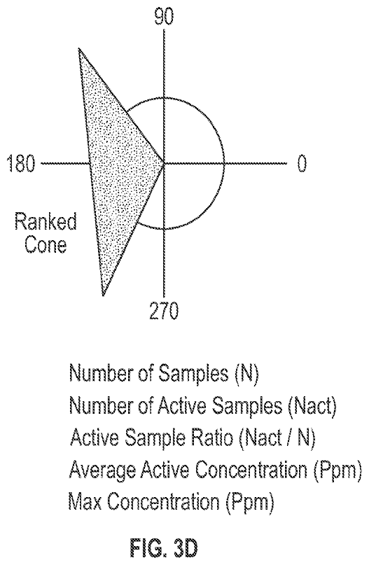

The following figures demonstrate schematically the cone generation procedure. FIG. 3A shows the data processing steps, followed by wedge and cone identification in FIGS. 3B and 3C, respectively. The cone acceptance conditions are given in FIG. 3D if only one valid cone is sought. If appropriate, all the cones can be returned for consideration.

Processing the wind-sensor data for all sensors will yield a set of valid cones, each described by two linear cuts. The collection of linear cuts (as equations) yield the constraint set G(X) along with the reduced bounds [CLB CUB] that can be imposed on the inversion problem as stated in FIG. 1. Here, the reduced bounds may replace the original stipulated bounds for the search, given by [LB UB].

### FIG. 3A—Cone Generation—Data Processing

Cone Generation—Data Processing SDAT is the input data for a given sensor comprising wind direction (deg), wind speed (m/s) and concentration (ppm) per row. The data is filtered according to a minimum concentration threshold and a desirable speed range (e.g., [2 8]m/s), giving the array ADAT. This array is sorted by wind direction as SADAT and is used to identify valid cones.

### FIG. 3B—Cone Generation—Wedge Identification

Referring to FIG. 3B, the data in array SADAT is used to identify wedges, or blocks of data, comprising active concentration measurements and those which do not.

### FIG. 3C—Cone Generation—Cone Identification

Referring to FIG. 3C, a merge wedge flag is assigned based on the gap between wedges. If the gap is less than the minimum cone separation angle, the wedges are merged into a larger cone. The process repeats until only acceptable cones remain.

### FIG. 3D—Cone Generation—Acceptance Criteria

Referring to FIG. 3D, The cone selection criteria are used to rank and select the major cone of interest. If the stipulated accept conditions are met, a valid cone is returned for the given sensor. The same procedure is applied to each sensor. Note that each cone (with known width and angles [min, middle, max]) yields two linear cuts. These are gathered in the constraint set G(X) for use in the subsequent inversion step.

### Example—Case 26 with 6 Sensors

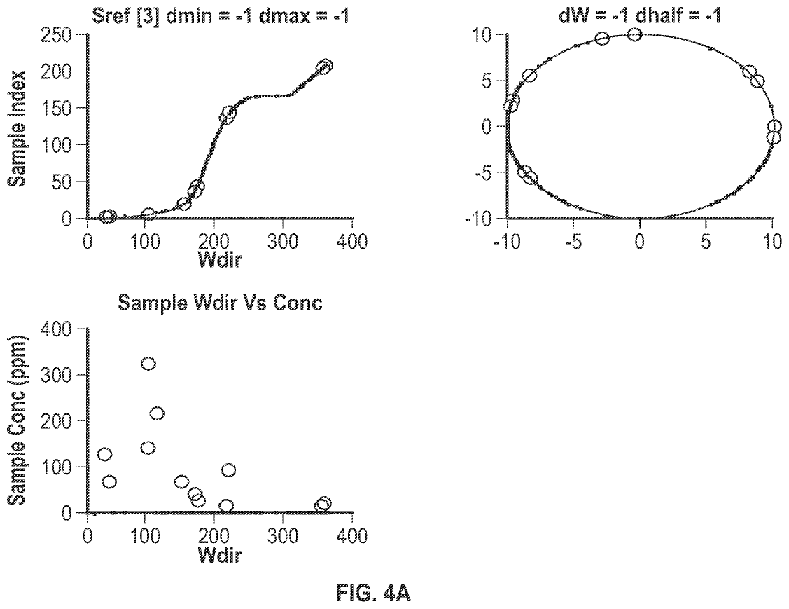

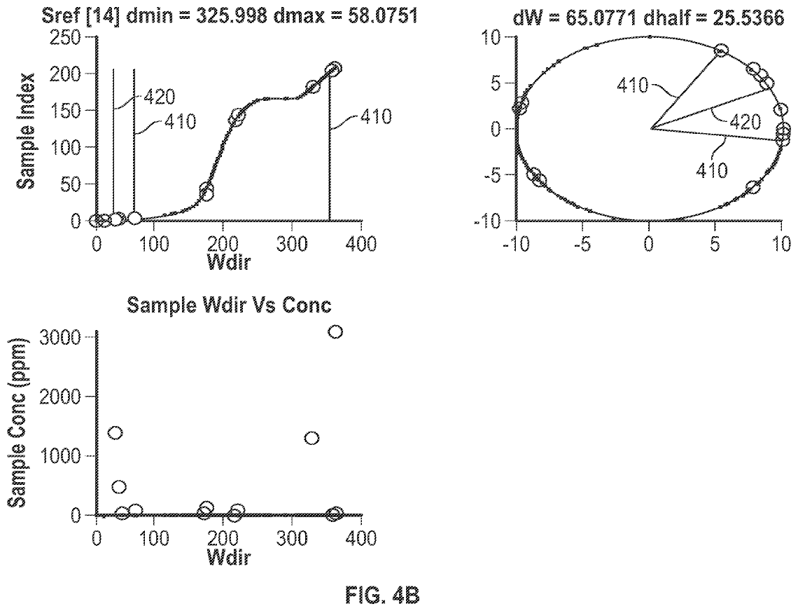

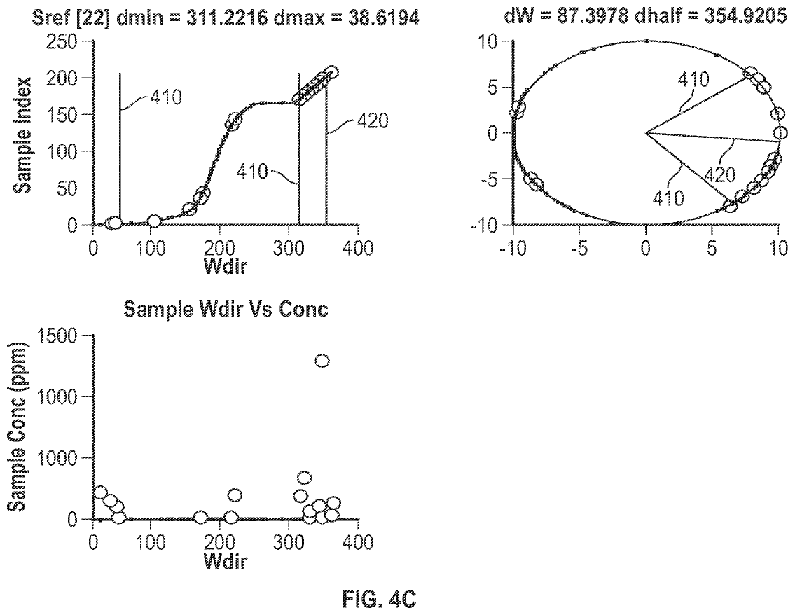

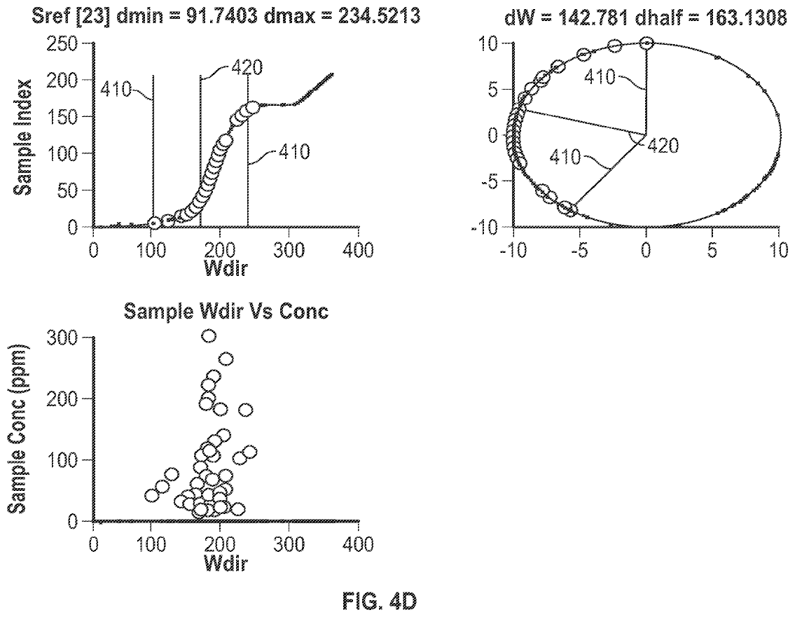

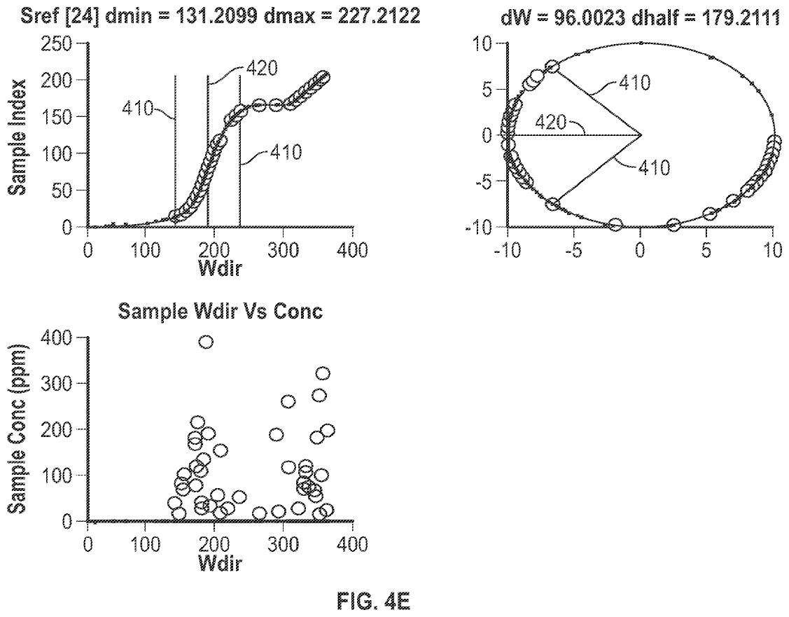

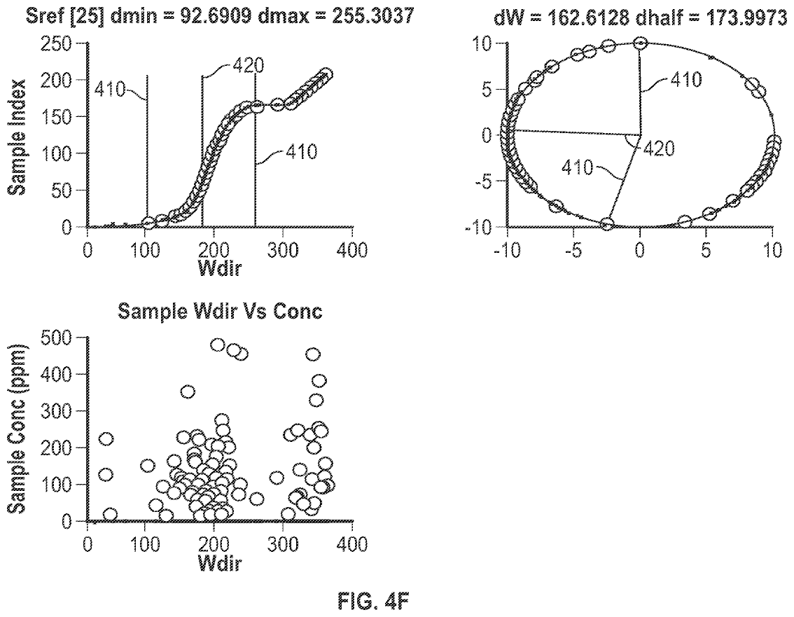

Six sensors are used in this example, with index values [3 14 22 23 24 25]. The cone generation plots are shown in FIGS. 4A to 4F. Each of FIGS. 4A to 4F comprises 3 sub-plots. The top-left plot shows sample index with wind direction. The dots indicate inactive samples, while the circles mark the active samples with concentration levels above the stipulated detection threshold (including the background). A low gradient indicates a faster changing wind direction (less stable), while a higher slope indicates that a greater number of samples are preferentially obtained at a similar wind direction (more stable). If a valid cone is identified, the minimum and maximum receptivity angles are marked by lines 410 and the mid-angle is given by a line 420 (as per the procedure described above). The same information is presented in circular wind direction plot in the top-right. This shows clearly the active samples, the receptivity angles and the shape of the resulting cone. Lastly, the concentration level with wind direction is shown at the bottom.

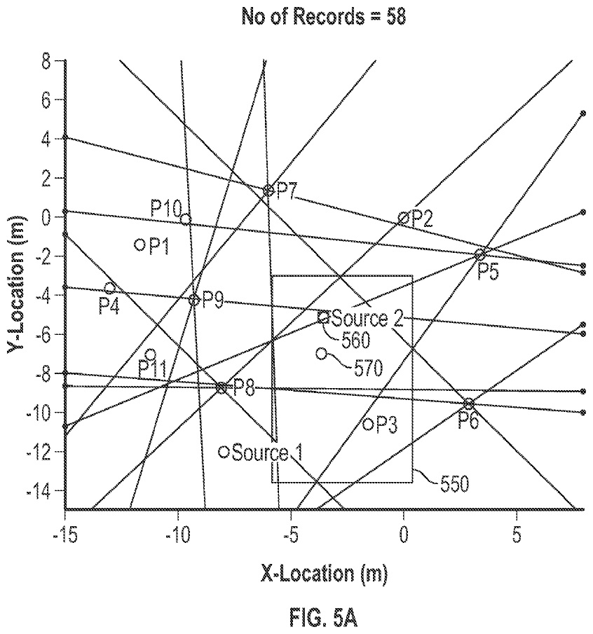

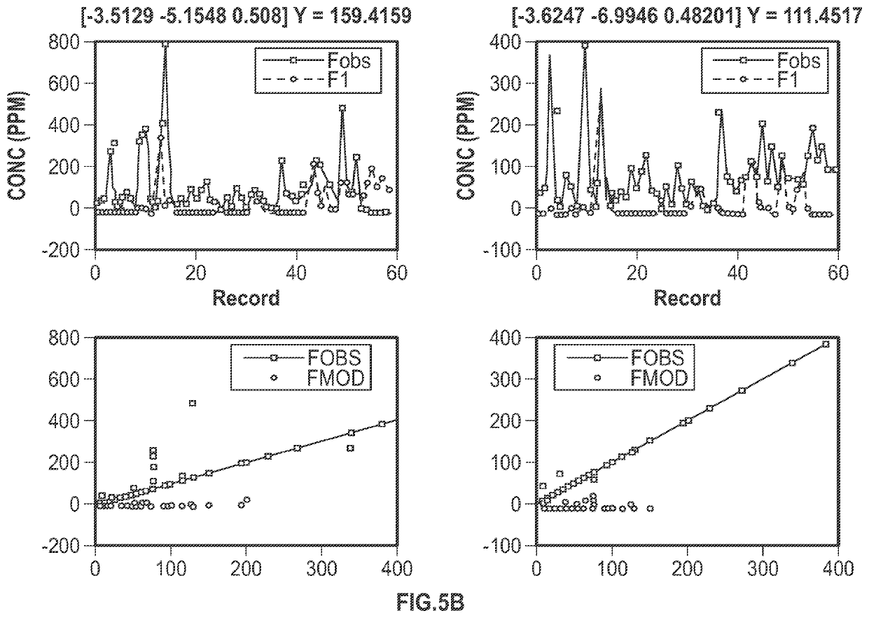

FIGS. 5A and 5B show the constrained case plan view and evaluation plots, respectively. Note that the cones shown in FIGS. 4A to 4F are projected on the plan view using the vertical angle at each sensor. This identifies the feasible sub-space 550. The solution is close to the known source in FIG. 5A.

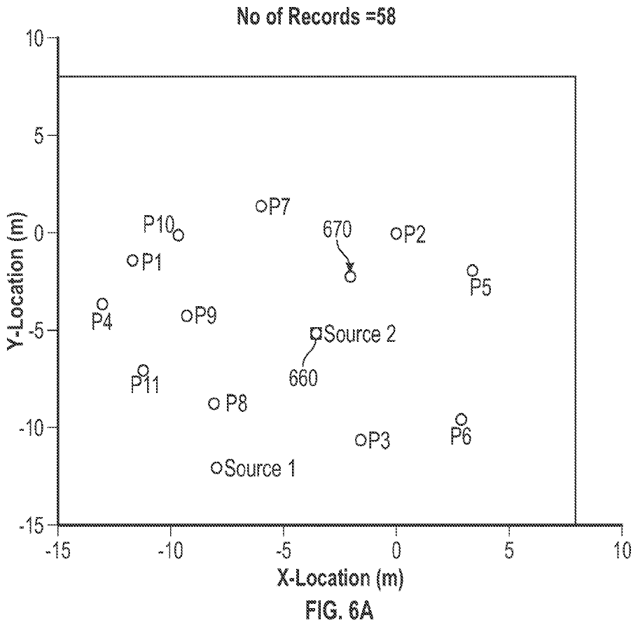

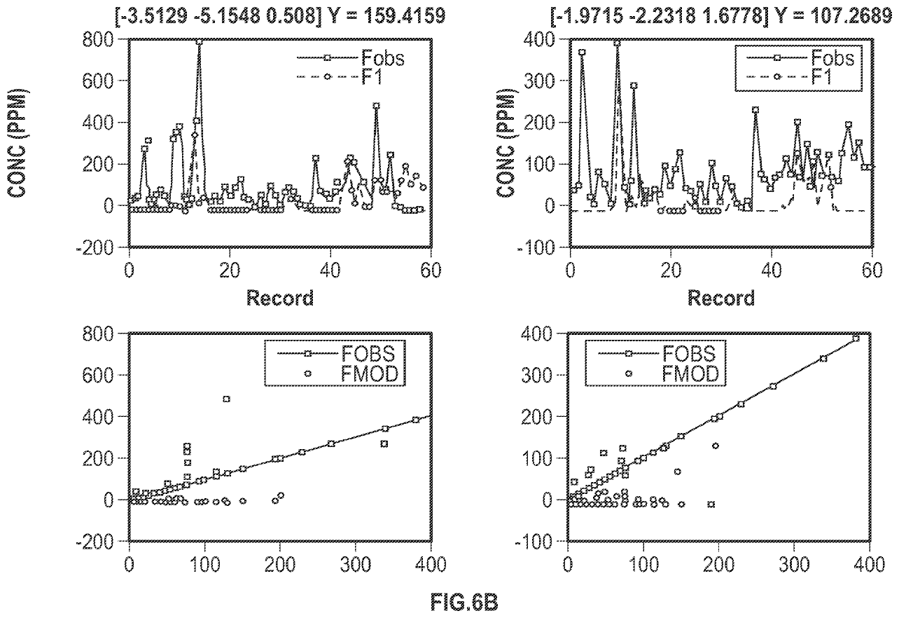

The equivalent plots for the unconstrained case (with no cone generation) are shown in FIGS. 6A and 6B, respectively, for comparative purposes. In FIG. 6A, the solution is also near the known source.

### FIG. 4A—Cone Generation Plots—Sensor 3 on Pole 2

Referring to FIG. 4A, a cone generation plot for sensor 3 is shown. In the FIG, the FIG. illustrates wind direction vs. sample index in the top left plot, circular direction plot in the top right plot, and wind direction vs. concentration (ppm) in the bottom plot. Active samples are depicted with circles and inactive samples are depicted with dots.

### FIG. 4B—Cone Generation Plots—Sensor 14 on Pole 5

Referring to FIG. 4B, a cone generation plot for sensor 14 is shown. In the FIG., the FIG. illustrates wind direction vs. sample index in the top left plot, circular direction plot in the top right plot, and wind direction vs. concentration (ppm) in the bottom plot. Active samples are depicted with circles, inactive samples are depicted with dots, angles (dₘᵢₙ and dₘₐₓ) are shown by reference line 410, and the mid-angle is shown by reference line 420.

### FIG. 4C—Cone Generation Plots—Sensor 22 on Pole 6

Referring to FIG. 4C, a cone generation plot for sensor 22 is shown. In the FIG., the FIG. illustrates wind direction vs. sample index in the top left plot, circular direction plot in the top right plot, and wind direction vs. concentration (ppm) in the bottom plot. Active samples are depicted with circles, inactive samples are depicted with dots, angles (dₘᵢₙ and dₘₐₓ) are shown by reference line 410, and the mid-angle is shown by reference line 420.

### FIG. 4D—Cone Generation Plots—Sensor 23 on Pole 7

Referring to FIG. 4D, a cone generation plot for sensor 23 is shown. In the FIG., the FIG. illustrates wind direction vs. sample index in the top left plot, circular direction plot in the top right plot, and wind direction vs. concentration (ppm) in the bottom plot. Active samples are depicted with circles, inactive samples are depicted with dots, angles (dₘᵢₙ and dₘₐₓ) are shown by reference line 410, and the mid-angle is shown by reference line 420.

### FIG. 4E—Cone Generation Plots—Sensor 24 on Pole 8

Referring to FIG. 4E, a cone generation plot for sensor 24 is shown. In the FIG., the FIG. illustrates wind direction vs. sample index in the top left plot, circular direction plot in the top right plot, and wind direction vs. concentration (ppm) in the bottom plot. Active samples are depicted with circles, inactive samples are depicted with dots, angles (dₘᵢₙ and dₘₐₓ) are shown by reference line 410, and the mid-angle is shown by reference line 420.

### FIG. 4F—Cone Generation Plots—Sensor 25 on Pole 9

Referring to FIG. 4F, a cone generation plot for sensor 24 is shown. In the FIG., the FIG. illustrates wind direction vs. sample index in the top left plot, circular direction plot in the top right plot, and wind direction vs. concentration (ppm) in the bottom plot. Active samples are depicted with circles, inactive samples are depicted with dots, angles (dₘᵢₙ and dₘₐₓ) are shown by reference line 410, and the mid-angle is shown by reference line 420.

### FIG. 5A—Case 26—Constrained—Plan

Referring to FIG. 5A, a constrained plan view with linear cuts, mid-angle, sub-bounds 550 is illustrated for case 26. Potential sources are depicted with a known source 560. The solution is shown by reference number 570.

### FIG. 5B—Case 26—Constrained—Objective

Referring to FIG. 5B, an objective evaluation at a known Source (left) and at a Solution (right) for case 26.

### FIG. 6A—Case 26—Constrained—Plan

Referring to FIG. 6A, a plan view full bounds is illustrated for case 26. Potential sources are depicted with a known source 660. The solution is shown by reference number 670.

### FIG. 6B—Case 26—Constrained—Objective

Referring to FIG. 6B, an objective evaluation at a known Source (left) and at a Solution (right) is illustrated for case 26.

### Multiple Cones

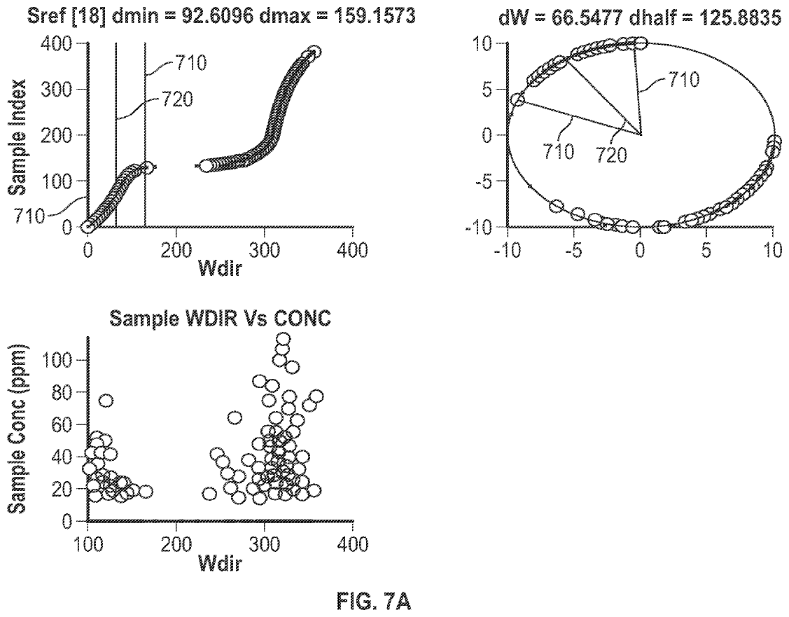

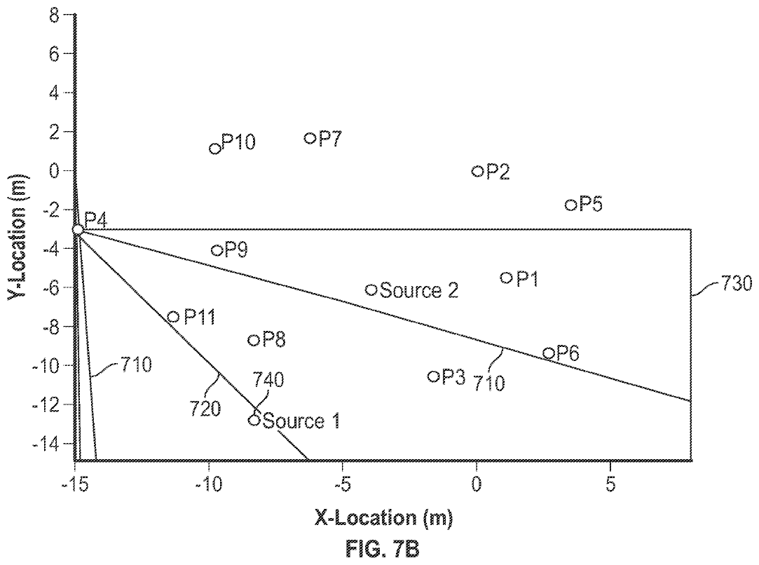

In the preceding example, FIGS. 4E and 4F both indicate the presence of one or more possible cones. The cone selection process dictates which is returned as the key cone, if only one is sought with the assumption of a single leak. In reality, however, we may encounter multiple leaks, and the cone generation plots effectively identify them. For example, in FIG. 7A there are 2 distinct cones in almost diametrically opposite directions. The selected cone correctly entraps the known source as shown in FIG. 7B. Clearly, the alternate cone would face in the wrong direction. This indicates a leak that is outside of the bounds of the search site. This information can also be used for cone selection.

### FIG. 7A—Multiple Cones

Referring to FIG. 7A, a cone generation plot for an example in which multiple leaks are encountered is shown. In the FIG., the FIG. illustrates wind direction vs. sample index in the top left plot, circular direction plot in the top right plot, and wind direction vs. concentration (ppm) in the bottom plot. Active samples are depicted with circles, inactive samples are depicted with dots, angles (dₘᵢₙ and dₘₐₓ) are shown by reference line 710, and the mid-angle is shown by reference line 720.

### FIG. 7B—Multiple Cones—Valid Cone Selected

Referring to FIG. 7B, a plan view with linear cuts 710, mid-angle 720, and sub-bounds 730 is shown. Potential sources are shown with the correct source 740 entrapped within the cone created by the linear cuts 710.

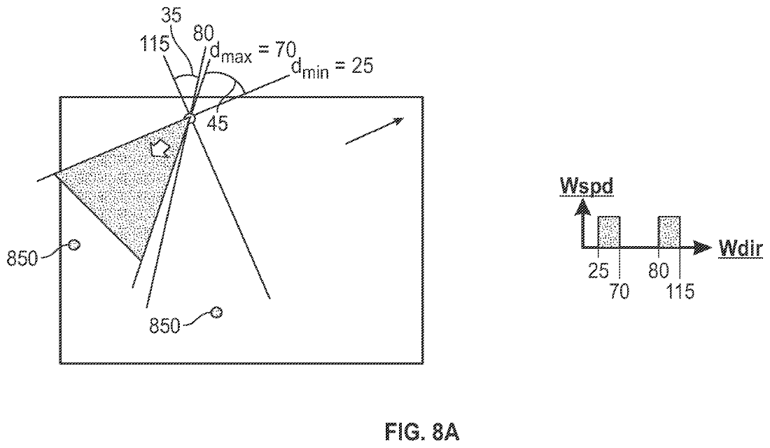

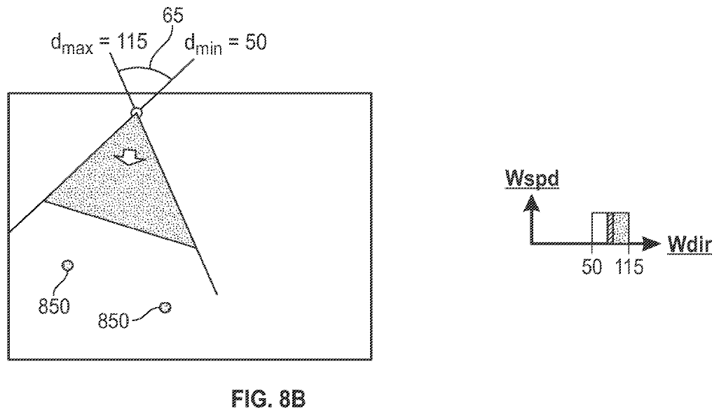

It is worth noting that identification of multiple valid cones within the search bounds effectively permits disambiguation of multiple sources. FIG. 8A shows the case where two potential sources 850 can be identified, while FIG. 8B shows the case where the two potential sources 850 cannot be separated. For the former case, information from one or more sensors could help identify multiple feasible sub-spaces. It is envisaged that each sub-space can be treated in turn as per the procedure described herein, where one source is assumed in the inversion step. This requires additional book-keeping to manage the sub-spaces identified.

### FIG. 8A—Multiple Cones—Separable

FIG. 8A shows two cones permitting dis-ambiguation of two potential sources (orange circles).

### FIG. 8B—Multiple Cones—Non-separable

FIG. 8B shows one large cone which prevents dis-ambiguation of two potential sources (orange circles).

In one example embodiment, a method for evaluating the presence of a methane leak is disclosed. The method may comprise performing a record generation event and performing a quality assessment of the record generation event. The method may also comprise performing a linear cut generation procedure to create a linear cut generation data set. The method may further comprise performing a source term inversion using the linear cut generation data set.

In another example embodiment, the method may further comprise establishing a wait period and pausing the method for a duration of the wait period.

In another example embodiment, the method may further comprise repeating the method.

In another example embodiment, the method may be performed wherein the record generation event involved, at least in part, sampling data from a number of fixed methane sensor deployed at a given site.

In another example embodiment, the method may be performed wherein the given site has known boundary conditions.

In another example embodiment, the method may be performed wherein the record generation event further includes recording data of at least one of wind speed and direction.

In another example embodiment, the method may be performed wherein the record generation event further includes recording at least one of a solar intensity and cloud cover for the given site.

In another example embodiment, the method may further comprise performing at least one single cone evaluation.

In another example embodiment, the method may be performed wherein the single cone evaluation comprises determining a minimum permissible size cone for the methane leak, wherein the cone represents a pathway for methane contaminants.

In another example embodiment, the method may be performed wherein the recorded data of wind speed and direction are filtered based on concentration above a minimum detection threshold.

In another example embodiment, the method may be performed wherein the recorded data of wind speed and direction are filtered based on wind speed strength.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may be varied in many ways. Such variations are not to be regarded as a departure from the disclosure, and all such modifications are intended to be included within the scope of the disclosure.

While embodiments have been described herein, those skilled in the art, having benefit of this disclosure, will appreciate that other embodiments are envisioned that do not depart from the inventive scope. Accordingly, the scope of the present claims or any subsequent claims shall not be unduly limited by the description of the embodiments described herein.

What is claimed is:

1. A method for evaluating the presence of a methane leak, comprising:
performing a record generation event;
performing a quality assessment of the record generation event;
performing a linear cut generation procedure to create a linear cut generation data set; and
performing a source term inversion using the linear cut generation data set.

2. The method according to claim 1, further comprising:
establishing a wait period; and
pausing the method for a duration of the wait period.

3. The method according to claim 2, further comprising:
repeating the method.

4. The method according to claim 1, wherein the record generation event involved, at least in part, sampling data from a plurality of fixed methane sensors deployed at a given site.

5. The method according to claim 4, wherein the given site has known boundary conditions.

6. The method according to claim 4, wherein the record generation event further includes recording data of at least one of wind speed and direction.

7. The method according to claim 6, wherein the record generation event further includes recording at least one of a solar intensity and cloud cover for the given site.

8. The method according to claim 6, further comprising:
performing at least one single cone evaluation.

9. The method according to claim 8, wherein the single cone evaluation comprises:
determining a minimum permissible size cone for the methane leak, wherein the cone represents a pathway for methane contaminants.

10. The method according to claim 6, wherein the recorded data of wind speed and direction are filtered based on a concentration above a minimum detection threshold.

11. The method according to claim 6, wherein the recorded data of wind speed and direction are filtered based on wind speed strength.

12. A method for evaluating the presence of at least two methane leaks, comprising:
performing a record generation event;
performing a quality assessment of the record generation event;
performing a linear cut generation of the record generation event after the quality assessment to create a linear cut generation data set;
performing a source term inversion of the linear cut generation data set;
performing at least two single cone evaluations;
determining at least a first of the at least two methane leaks using the at least two single cone evaluations; and
determining at least a second of the at least two methane leaks using the at least two cone evaluations.
